(19) United States
(12) Patent Application Publication
(10) Pub. No.: US 2023/0318383 A1
(43) Pub. Date: Oct. 5, 2023

(54) CONNECTION STRUCTURE FOR ELECTRIC MOTOR

(71) Applicant: TOYOTA JIDOSHA KABUSHIKI KAISHA, Toyota-shi (JP)

(72) Inventor: Keiichi KANESHIGE, Seto-shi (JP)

(73) Assignee: TOYOTA JIDOSHA KABUSHIKI KAISHA, Toyota-shi (JP)

(21) Appl. No.: 18/128,823

(22) Filed: Mar. 30, 2023

(30) Foreign Application Priority Data
Apr. 1, 2022 (JP) 2022-062108

(51) Int. Cl. H02K 3/28

(52) U.S. Cl. CPC H02K 3/28; H02K 2203/09

(57) ABSTRACT

A connection structure for connecting between a stator coil of an electric motor and a connector connected to a power source. The connection structure includes: (a) at least one first connection line each connected to the stator coil; (b) at least one first terminal each fixed to a connector-side end portion of a corresponding of the at least one first connection line; (c) a plurality of second connection lines connected to respective terminal portions of the connector; (d) at least one second terminal each fixed to coil-side end portions of the respective second connection lines; and (e) a terminal block including at least one attached portion. Each of the at least one first terminal and a corresponding one of the at least one second terminal are attached to a corresponding one of the at least one attached portion of the terminal block, and are connected to each other.

This application claims priority from Japanese Patent Application No. 2022-062108 filed on Apr. 1, 2022, the disclosure of which is herein incorporated by reference in its entirety.

### FIELD OF THE INVENTION

The present invention relates to a connection structure for connecting between a coil of a stator of an electric motor and a connector connected to a power source.

### BACKGROUND OF THE INVENTION

There is known a connection structure for connecting between a coil of a stator of an electric motor and a connector connected to a power source. A connection structure disclosed in JP-2008-172898A is an example of such a connection structure. The electric motor described in this Japanese Patent Application Publication is a three-phase AC motor.

### SUMMARY OF THE INVENTION

By the way, in the connection structure disclosed in the above-identified Japanese Patent Application Publication, an end portion of a coil wire corresponding to each phase of a three-phase alternating current that drives the electric motor is connected to a power source disposed outside the electric motor through a connection line that is constituted by a single cable. That is, a power-source connection line connecting between a connector and the power source is also constituted by a single cable for each phase. In order to suppress increase of power loss and increase of heat generation, it is necessary to increase a cross-sectional area of the power-source connection line for each phase to at least a predetermined value. However, flexibility of the power-source connection line is reduced with increase of the cross-sectional area, and the reduced flexibility of the power-source connection line makes it difficult to dispose the power-source connection line between the connector and the power source, thereby causing a risk that workability could be reduced when the power-source connection line is to be connected between the connector and the power source.

The present invention was made in view of the background art described above. It is therefore an object of the present invention to provide a connection structure for an electric motor, wherein the connection structure is capable of improving workability when a power-source connection line is to be connected between a connector and a power source.

The object indicated above is achieved according to the following aspects of the present invention.

According to a first aspect of the invention, there is provided a connection structure for connecting between a coil of a stator of an electric motor and a connector connected to a power source. The connection structure includes: (a) at least one first connection line each of which connected to the coil and includes a connector-side end portion; (b) at least one first terminal each of which is fixed to the connector-side end portion of a corresponding of the at least one first connection line; (c) a plurality of second connection lines connected to respective terminal portions of the connector and including respective coil-side end portions that are jointed to each other; (d) at least one second terminal each of which is fixed to the coil-side end portions of the respective second connection lines; and (e) a terminal block including at least one attached portion. Each of the at least one first terminal and a corresponding one of the at least one second terminal are attached to a corresponding one of the at least one attached portion of the terminal block, and are connected to each other.

According to a second aspect of the invention, in the connection structure according to the first aspect of the invention, each of the at least one first terminal includes a fixed portion at which the each of the at least one first terminal is fixed to the connector-side end portion of a corresponding one of the at least one first connection line. Each of the at least one second terminal includes a fixed portion at which the each of the at least one second terminal is fixed to the coil-side end portions of the respective second connection lines. Each of the at least one first terminal further includes a contact portion and each of the at least one second terminal further includes a contact portion, such that the contact portion of each of the at least one first terminal and the contact portion of a corresponding one of the at least one second terminal both lie on a common plane so as to be in contact with each other. The connector-side end portion of each of the at least one first connection line and the coil-side end portions of the respective second connection lines are located on respective opposite sides of the common plane.

According to a third aspect of the invention, in the connection structure according to the second aspect of the invention, the at least one first terminal consists of three first terminals, the at least one second terminal consists of three second terminals, and the at least one attached portion of the terminal block consists of three attached portions, such that each of the three first terminals and a corresponding one of the three second terminals are attached to a corresponding one of the three attached portions, and such that the three second terminals are fixed to the coil-side end portions of three sets of the second connection lines. The coil-side end portions of the three sets of the second connection lines extend in a predetermined direction. At least one of the three attached portions is offset from the other of the three attached portions in a direction orthogonal to the predetermined direction.

According to a fourth aspect of the invention, in the connection structure according to the third aspect of the invention, the three attached portions are located in respective three positions that cooperate with one another to define an isosceles triangle as seen from a direction perpendicular to the common plane. Two of three sides of the isosceles triangle have the same length that is smaller than a length of another one of the three sides.

In the connection structure according to the first aspect of the invention, each of the at least one first terminal (which is fixed to the connector-side end portion of a corresponding one of the at least one first connection line) and a corresponding one of the at least one second terminal (which is fixed to the coil-side end portions of the respective second connection lines) are attached to a corresponding one of the at least one attached portion of the terminal block, and are connected to each other. Thus, in each of the attached portions of the terminal block, a corresponding one of the at least one first terminal which is fixed to the connector-side end portion of a corresponding one of the at least one first connection line, is connected to a corresponding one of the at least one second terminal which is fixed to the coil-side end portions of the respective second connection lines, wherein the coil-side end portions of the respective second connection lines are bundled or joined to each other. That is, each of the at least one first connection line is branched into the plurality of second connection lines, and is connected to the plurality of terminal portions of the connector. Therefore, a number of power-source connection lines connecting between the connector and the power source is larger than a number of the at least one first connection line. Owing to this feature, even where a cross-sectional area of each one of the power-source connection lines is reduced, it is possible to suppress increase of power loss and increase of heat generation in the power-source connection lines as a whole. Where the cross-sectional area of each one of the power-source connection lines is reduced, flexibility of each one of the power-source connection lines is increased whereby the power-source connection lines can be disposed between the connector and the power source so that it is possible to improve workability when the power-source connection lines are to be connected between the connector and the power source.

In the connection structure according to the second aspect of the invention, the connector-side end portion of each of the at least one first connection line (to which a corresponding one of the at least one first terminal is fixed) and the coil-side end portions of the respective second connection lines (to which a corresponding one of the at least one second terminal is fixed) are located on respective opposite sides of the common plane (on which the contact portion of the corresponding one of the at least one first terminal and the contact portion of the corresponding one of the at least one second terminal both lie). As compared with an arrangement in which the connector-side end portion of each of the at least one first connection line and the coil-side end portions of the respective second connection lines are both located on the same side as one of the opposite sides of the common plane, in this arrangement in which the connector-side end portion and the coil-side end portions are located on the respective opposite sides of the common plane, when the first and second terminals fixed to the connector-side end portion and the coil-side end portions are to be attached to the attached portions of the terminal block, they can be easily attached to the attached portions even where only a small space is available for such an attaching operation, because the connector-side end portion and the coil-side end portions are located on the respective opposite sides of the common plane and are not likely to interfere with each other.

In the connection structure according to the third aspect of the invention, the at least one first terminal consists of three first terminals, the at least one second terminal consists of three second terminals, and the at least one attached portion of the terminal block consists of three attached portions, and the coil-side end portions of the three sets of the second connection lines, to which the three second terminals are fixed, extend in the predetermined direction, i.e., the same direction, wherein at least one of the three attached portions is offset from the other of the three attached portions in a direction orthogonal to the predetermined direction. The feature that at least one of the three attached portions is offset from the other of the three attached portions in a direction orthogonal to the predetermined direction, means that the three attached portions do not lie on a single straight line that extends in a direction orthogonal to the predetermined direction. As compared with an arrangement in which all of the three attached portions lie on a single straight line, in this arrangement in which the three attached portions do not lie on a single straight line, when the three second terminals, which are fixed to the coil-side end portions of the three sets of the second connection lines, are to be attached to the three attached portions of the terminal block, they can be easily attached to the respective three attached portions even where only a small space is available for such an attaching operation in the terminal block, because the three second terminals are not likely to interfere with one another.

In the connection structure according to the fourth aspect of the invention, the three attached portions are located in respective three positions that cooperate with one another to define an isosceles triangle as seen from a direction perpendicular to the common plane, and two of three sides of the isosceles triangle have the same length that is smaller than a length of another one of the three sides. The feature that the three positions of the respective three attached portions cooperate with one another to define the isosceles triangle as seen from the direction perpendicular to the common plane, means that the three attached portions do not lie on a single straight line. Owing this feature, when the three second terminals, which are fixed to the coil-side end portions of the three sets of the second connection lines, are to be attached to the three attached portions of the terminal block, the three second terminals are not likely to interfere with one another. Further, since two of the three sides of the isosceles triangle have the same length that is smaller than a length of another one of the three sides, it is possible to reduce a size of the terminal block, without reducing distances among the three attached portions, as seen from a direction perpendicular to the common plane, as compared with an arrangement in which the two of the three sides of the isosceles triangle, which have the same length, are longer than the other one of the three sides. Thus, it is possible to establish a structure, which enables the three second terminals to be unlikely to interfere with one another in the attaching operation for attaching the three second terminals to the respective three attached portions, and which reduces the size of the terminal block as seen in the direction perpendicular to the common plane.

### BRIEF DESCRIPTION OF THE DRAWINGS

FIG. 1 is a view showing an entirety of a connection structure for an electric motor, wherein the connection structure is constructed according to an embodiment of the present invention;

FIG. 2 is a perspective view showing the connection structure of FIG. 1, particularly, power line cables and first crimp terminals that are included in the connection structure;

FIG. 3 is a perspective view showing the connection structure of FIG. 1, particularly, internal cables and second crimp terminals that are included in the connection structure; and

FIG. 4 is a view showing a positional relationship among three attached portions to which the first crimp terminals and the second crimp terminals are attached, wherein the first crimp terminals are fixed to the power line cables while the second crimp terminals are fixed to the internal cables.

### DETAILED DESCRIPTION OF PREFERRED EMBODIMENT

Hereinafter, there will be described preferred embodiment in detail with reference to the accompanying drawings. It is noted that figures of the drawings are simplified or deformed as needed, and each portion is not necessarily precisely depicted in terms of dimension ratio, shape, etc.

### EMBODIMENT

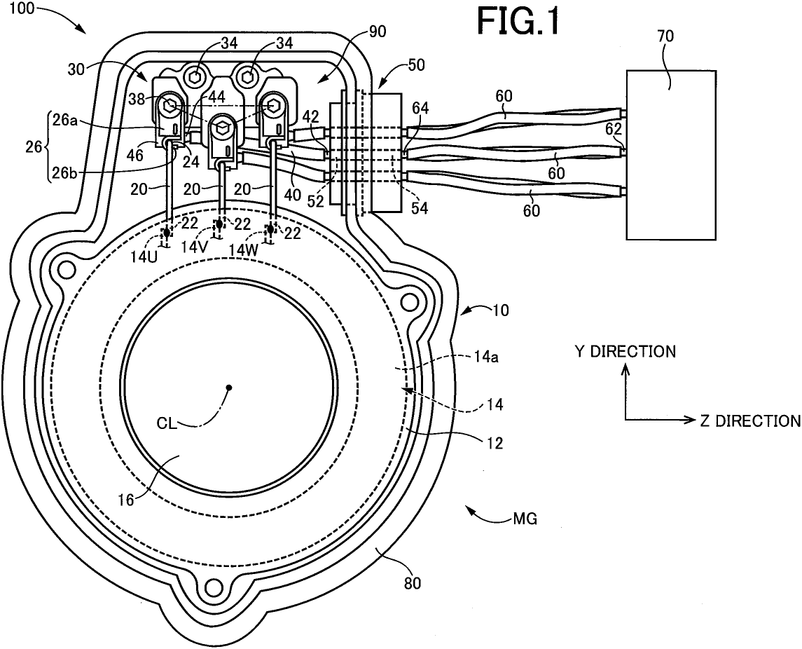

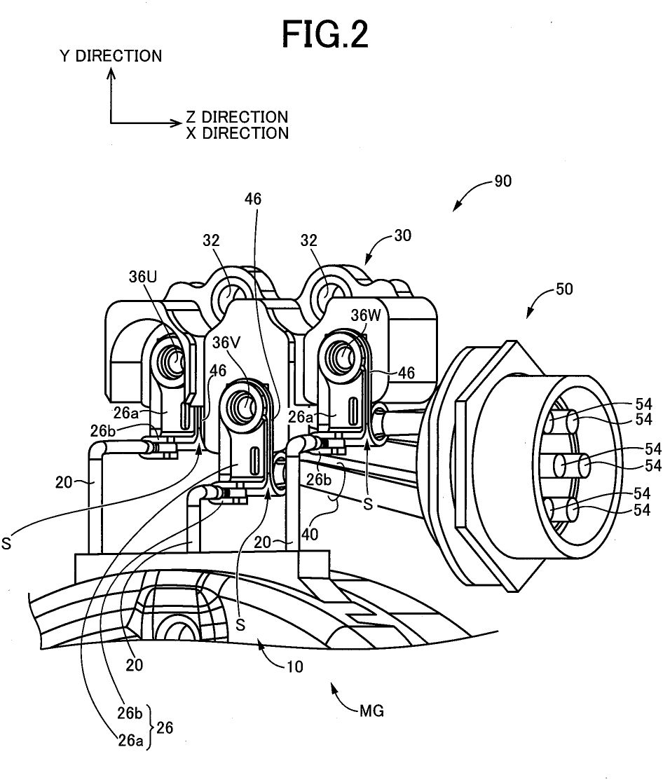

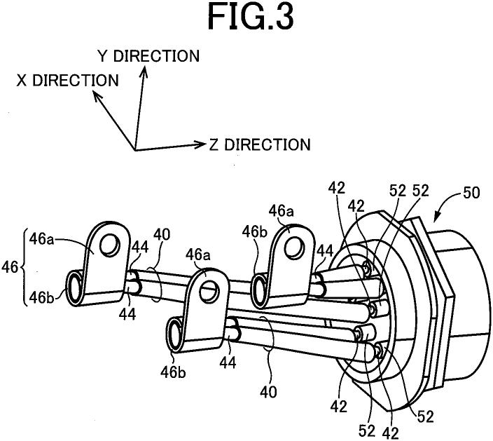

FIG. 1 is a view showing an entirety of a connection structure 90 for an electric motor MG, wherein the connection structure 90 is constructed according to an embodiment of the present invention, as viewed from an X direction that is perpendicular to drawing sheet of FIG. 1. The X direction is parallel to an axis CL of the electric motor MG, and is orthogonal to a Y direction and a Z direction which are shown in FIGS. 2 and 3 and which are orthogonal to each other. In FIG. 1, a casing 80 is shown only in its part.

The electric motor MG is a rotary electric machine that is to be provided in an electrically operated vehicle 100 such as a hybrid electric vehicle and an electric vehicle. The electric motor MG is, for example, a so-called motor generator having a function (motor function) serving as an electric motor and also a function serving as a generator. The electric motor MG, which is a three-phase synchronous motor, is to be used as a drive power source for driving the vehicle 100, for example.

The electric MG includes a tubular-shape stator 10 centered on the axis CL and a rotor 16 disposed on an inner peripheral side of the stator 10. The rotor 16 is rotatable about the axis CL by a rotating magnetic field generated by the stator 10.

The stator 10 includes a stator core 12, a coil 14 and power line cables 20. The stator core 12 having a tubular shape and centered on the axis CL is constituted by, for example, a plurality of electromagnetic steel plates that are superposed on each other. The tubular-shaped stator core 12 has a plurality of tooth portions provided in its inner circumferential surface, such that the tooth portions protrude from the inner circumferential surface inwardly in a radial direction of the stator core 12 and extend in parallel to the axis CL. The coil 14 is wound on the tooth portion of the stator core 12.

The coil 14 is constituted by, for example, a three-phase winding of U-phase, V-phase and W-phase. The coil 14 includes a pair of coil ends 14a that are provided by outwardly protruding portions of the coil 14, which protrude outwardly from axially opposite ends of the stator core 12 in a direction of the axis CL (hereinafter referred to as “axis CL direction”.

The power line cables 20 are constituted by, for example, elongated metal plates, and correspond to “at least one first connection line” recited in the appended claims. Each of the power line cables 20 is electrically fixed at its end portion 22 to an end portion of the three-phase winding in one of the coil ends 14a through welding. That is, the end portions 22 of the respective power line cables 20 are fixed to a U-phase end portion 14U, a V-phase end portion 14V and a W-phase end portion 14W, respectively, as shown in FIG. 1, wherein the U-phase end portion 14U, V-phase end portion 14V and W-phase end portion 14W are end portions of the respective U phase, V phase and W phase of the coil 14.

The connection structure 90 can be sectioned into three portions provided for the respective three phases, which are substantially the same in construction as one another except for positions of respective attached portions 36 of a terminal block 30, which will be described later. Therefore, regarding parts common to the three portions of the connection structure 90, only one of the three portions will be described.

Each of first crimp terminals 26, which is attached to a corresponding one of the attached portions 36, is a conductive member made of a conductive material such as aluminum and copper. Each first crimp terminal 26 includes a plate portion 26a and a crimp portion 26b. The plate portion 26a is a portion at which the first crimp terminal 26 is attached to the attached portion 36 of the terminal block 30, and has a through-hole. The crimp portion 26b is a portion at which the first crimp terminal 26 is fixed to the power line cable 20 with the crimp portion 26b being crimped onto the power line cable 20. The crimp portion 26b is constituted by a longitudinal end portion of the plate portion 26a that is bent in its thickness direction, wherein the longitudinal end portion is an end portion of the plate portion 26a in a longitudinal direction of the plate portion 26a that corresponds to the Y direction. The plate portion 26a and the crimp portion 26b correspond to “contact portion” and “fixed portion”, respectively, which are recited in the appended claims.

The power line cable 20 extends from the end portion 22 toward outside the stator core 12 in the Y direction, and then is bent in L shape in the axis CL direction, so that another end portion 24 extends in the axis CL direction. The other end portion 24 corresponds to “connector-side end portion” recited in the appended claims.

The other end portion 24 of the power line cable 20 is crimped by the crimp portion 26b of the first crimp terminal 26. That is, the first crimp terminal 26 is fixed to the other end portion 24 that is an end portion of the power line cable 20, which is remote from the coil 14. The other end portion 24 of the power line cable 20, which is crimped by the crimp portion 26b of the first crimp terminal 26, is located on one of opposite sides of the plate portion 26a of the first crimp terminal 26. The first crimp terminal 26 corresponds to “first terminal” recited in the appended claims.

The vehicle 100 includes a power control unit 70 (hereinafter referred to as “PCU 70”) in addition to the above-described electric motor MG, casing 80, terminal block 30 and connector 50.

The casing 80 is a non-rotary member that is fixed to, for example, a body of the vehicle 100. The casing 80 stores therein the electric motor MG and the terminal block 30. The stator 10 is fixed to the casing 80.

The connector 50 is a coupler through which elements or members inside the casing 80 and those outside the casing 80 are connected or coupled. The connector 50 is disposed in a through-hole provided in the casing 80 so as to close the through-hole, and is fixed to the casing 80. The connector 50 is sectioned into an inside portion located inside the casing 80 and an outside portion located outside the casing 80. The outside portion of the connector 50 is provided with six outside terminal portions 54, wherein each two of the six outside terminal portions 54 are provided for a corresponding one of three phases of the three-phase winding, as shown in FIG. 2. The inside portion of the connector 50 is provided with six inside terminal portions 52 that are electrically connected to the respective six outside terminal portions 54. The inside terminal portions 52 correspond to “terminal portions” recited in the appended claims.

The PCU 70 is configured to convert DC power supplied from a storage battery (not shown), into AC power, and to supply the AC power to the electric motor MG, so as to drive the electric motor MG. Further, the PCU 70 is configured to convert the AC power generated by the electric motor MG, into the DC power, and to store the DC power in the storage battery. For example, when the electric motor MG is to be driven and rotated, the three-phase AC power is outputted from the PCU 70 to the coil 14 of the electric motor MG. That is, from the perspective of the electric motor MG, the PCU 70 serves also as a power source that supplies the electric power to drive the electric motor MG. The PCU 70 corresponds to “power source” recited in appended claims.

The PCU 70 and the connector 50 are electrically connected through external cables 60, as shown in FIG. 1. That is, each of the external cables 60 is connected at an end portion 62 thereof to the PCU 70 and is connected at another end portion 64 to a corresponding one of the outside terminal portions 54 of the connector 50. Th external cables 60 serve as power-source connection lines for connecting between the PCU 70 as the power source and the connector 50.

FIG. 2 is a perspective view showing the connection structure 90, particularly, the power line cables 20 and the first crimp terminals 26 that are included in the connection structure 90. FIG. 3 is another perspective view showing the connection structure 90, particularly, the internal cables 40 and second crimp terminals 46 that are included in the connection structure 90. The perspective view of FIG. 2 is as viewed from a direction perpendicular to the Y direction and inclined with respect to both of the X direction and Z direction. The perspective view of FIG. 3 is as viewed from a direction inclined with respect to all of the X direction, Y direction and Z direction. It is noted that the power line cables 20 and the terminal block 30 are not illustrated in FIG. 3.

Each of the second crimp terminals 46, which is attached to a corresponding one of the attached portions 36, is a conductive member made of a conductive material such as aluminum and copper. Each second crimp terminal 46 includes a plate portion 46a and a crimp portion 46b. The plate portion 46a is a portion at which the second crimp terminal 46 is attached to the attached portion 36 of the terminal block 30, and has a through-hole. The crimp portion 46b is a portion at which the second crimp terminal 46 is fixed to the internal cables 40 with the crimp portion 46b being crimped onto the internal cables 40. The crimp portion 46b is constituted by a longitudinal end portion of the plate portion 46a that is bent in its thickness direction, wherein the longitudinal end portion is an end portion of the plate portion 46a in a longitudinal direction of the plate portion 46a that corresponds to the Y direction. The plate portion 46a and the crimp portion 46b correspond to “contact portion” and “fixed portion”, respectively, which are recited in the appended claims.

The power line cables 20 and the connector 50 are electrically connected through the internal cables 40. Each of the internal cables 40 is electrically connected at its end portion 42 to a corresponding one of the inside terminal portions 52 provided in the connector 50 through soldering. Each two of the six internal cables 40, which are provided for a corresponding one of three phases of the three-phase winding, are bundled or joined at the other end portions 44 to each other, and are crimped by the crimp portion 46b of a corresponding one of the three second crimp terminals 46. It is preferable that that each two internal cables 40 and the crimp portion 46b of the corresponding second crimp terminal 46 are electrically connected through not only crimping but also soldering. The other end portions 44 of each two of the six internal cables 40, which are crimped by the crimp portion 46b of the corresponding second crimp terminal 46, are located on one of opposite sides of the plate portion 46a of the second crimp terminal 46. Thus, the second crimp terminals 46 are fixed to the other end portions 44 that are end portions of the internal cables 40, which are remote from the connector 50. Each of the second crimp terminals 46 corresponds to “second terminal” recited in the appended claims. The other end portions 44 corresponds to “coil-side end portions” recited in the appended claims.

The terminal block 30 has through-holes 32, so as to be fixed to the casing 80. Specifically, the terminal block 30 is fixed inside the casing 80 through fasteners 34 (e.g., bolts as shown in FIG. 1) that passe through the respective through-holes 32.

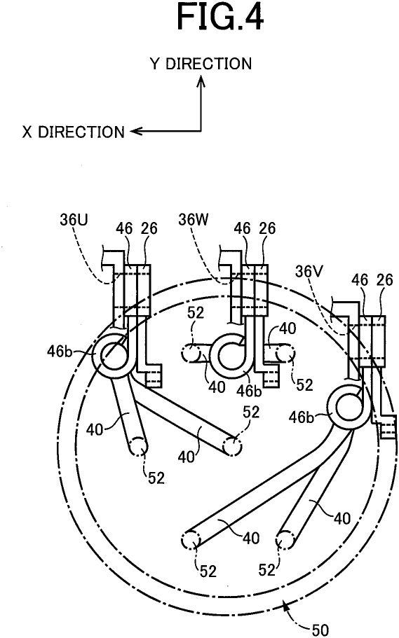

The terminal block 30 is provided with the three attached portions 36 for the respective three phases. To each of the three attached portions 36, a corresponding one of the three first crimp terminals 26 (that are fixed to the three power line cables 20) and a corresponding one of the three second crimp terminals 46 are attached, so that the corresponding first crimp terminal 26 and the corresponding second crimp terminal 46 are electrically connected to each other. The three attached portions 36 consist of a U-phase attached portion 36U for the U phase, a V-phase attached portion 36V for the V phase and a W-phase attached portion 36W for the W phase. The attached portions 36 have respective holes (see FIG. 4) for fixing the first and second crimp terminals 26, 46 so as to electrically connecting the first and second crimp terminals 26, 46.

Each of the three first crimp terminals 26 and a corresponding one of the three second crimp terminals 46 are held in contact at their respective plate portions 26a, 46a with each other, and are attached to a corresponding one of the three attached portions 36 through a fastener 38 (e.g., bolt as shown in FIG. 1). Specifically, the fastener 38 passes through a through-hole provided in the plate portion 26a of the first crimp terminal 26 and a through-hole provided in the plate portion 46a of the second crimp terminal 46, and is fixed in the hole of the attached portion 36. Thus, with the plate portion 26a of the first crimp terminal 26 and the plate portion 46a of the second crimp terminal 46 being pressed against each other in their thickness direction by the fastener 38, the first and second crimp terminals 26, 46 are held in contact with their plate portions 26a, 46a so as to be electrically connected to each other. Thus, in each of the three attached portions 36, a corresponding one pair of the first and second crimp terminals 26, 46 are electrically connected to each other. In the present embodiment, three pairs of the first and second crimp terminals 26, 46 are provided for the three phases of the three-phase winding, each one of the three pairs are attached to a corresponding one of three attached portions 36 so as to be electrically connected to each other. In other words, each one of the three power line cables 20 and corresponding two of the six internal cables 40 are electrically connected for a corresponding one of the three phases. Each two of the six internal cables 40 correspond to “plurality of second connection lines” recited in the appended claims.

The plate portion 26a of each of the three first crimp terminals 26 and the plate portion 46a of a corresponding one of the three second crimp terminals 46 lie on a common plane S so as to be in contact with each other. That is, the plate portions 26a of the respective three first crimp terminals 26 and the plate portions 46a of the respective three second crimp terminals 46, which are attached to the respective U-phase attached portion 36U, V-phase attached portion 36V and W-phase attached portion 36W, lie on the respective three common planes S, all of which are parallel to one another and perpendicular to the X direction. With the first and second crimp terminals 26, 46 being fixedly attached to the attached portions 36 of the terminal block 30, the other end portion 24 of each of the three power line cables 20, which is crimped by the crimp portion 26b of a corresponding one of the three first crimp terminals 26, and the other end portions 44 of each two of the six internal cables 40, which are crimped by the crimp portion 46b of a corresponding one of the three second crimp terminals 46, are located on respective opposite sides of a corresponding one of the three common planes S. That is, the other end portion 24 (as the connector-side end portion) of each power line cable 20 and the other end portions 44 (as the coil-side end portions) of corresponding two internal cables 40 are located on the respective opposite sides of the corresponding common plane S.

In the three attached portions 36 of the terminal block 30, all of the other end portions 44 of the three pairs of the internal cables 40 extend in the same direction, i.e., Z direction. Namely, in each of the three attached portions 36 of the terminal block 30, the other end portions 44 of a corresponding one of the three pairs of the internal cables 40, which are crimped by the crimp portion 46b of a corresponding one of the three second crimp terminals 46, extend in the Z direction. Each of the three pairs of the internal cables 40 extend in the Z direction at least in the other end portions 44, and then extend toward a corresponding one of the three pairs of the inside terminal portions 52 of the connector 50, as shown in FIG. 3.

FIG. 4 is a view showing a positional relationship among the three attached portions 36 to which the three first crimp terminals 26 and the three second crimp terminals 46 are attached, wherein the first crimp terminals 26 are fixed to the other end portions 24 of the power line cables 20 while the second crimp terminals 46 are fixed to the other end portions 44 of the internal cables 40. The view of FIG. 4 is a view as viewed from the Z direction that is perpendicular to drawing sheet of FIG. 4. In FIG. 4, the connector 50 is represented by one-dot chain line.

The three pairs of the first and second crimp terminals 26, 46, which are attached to the respective attached portions 36, are located in respective positions that are offset from one another, as viewed from the Z direction, as shown in FIG. 4. Specifically, the U-phase attached portion 36U, the V-phase attached portion 36V and the W-phase attached portions are offset from one another in the X direction. Further, the V-phase attached portion 36V is offset from the U-phase attached portion 36U and the W-phase attached portion 36W in the Y direction.

As shown in FIG. 1, the three attached portions 36 are located in respective three positions that cooperate with one another to define an isosceles triangle as seen from the X direction perpendicular to the common planes S, as indicated by one-dot chain lines in FIG. 1. That is, the isosceles triangle is defined by three straight lines, each of which connects between centers of the holes of corresponding two of the three attached portions 36. The defined isosceles triangle has three sides, where in two of the three sides have the same length that is larger than a length of another one of the three sides. More specifically, the side between the U-phase attached portion 36U and the V-phase attached portion 36V and the side between the V-phase attached portion 36V and the W-phase attached portion 36W are equal in length to each other, and are smaller in length than the side between the U-phase attached portion 36U and the W-phase attached portion 36W.

In the connection structure 90 according to the present embodiment, each of the three first crimp terminals 26 (which is fixed to the other end portion 24 of a corresponding one of the three power line cables 20) and a corresponding one of the three second crimp terminals 46 (which is fixed to the other end portions 44 of the respective internal cables 40) are attached to a corresponding one of the three attached portions 36 of the terminal block 30, and are connected to each other. Thus, in each of the three attached portions 36 of the terminal block 30, a corresponding one of the three first crimp terminals 26 which is fixed to the other end portion 24 of a corresponding one of the three power line cables 20, is connected to a corresponding one of the three second crimp terminals 46 which is fixed to the other end portions 44 of the respective internal cables 40, wherein the other end portions 44 of the respective internal cables 40 are bundled or joined to each other. That is, each of the three power line cables 20 is branched into the plurality of internal cables 40, and is connected to the two inside terminal portions 52 of the connector 50. Therefore, a number of the external cables 60 connecting between the connector 50 and the PCU 70 is larger than a number of the three power line cables 20. Owing to this feature, even where a cross-sectional area of each one of the external cables 60 is reduced, it is possible to suppress increase of power loss and increase of heat generation in the external cables 60 as a whole. Where the cross-sectional area of each one of the external cables 60 is reduced, flexibility of each one of the external cables 60 is increased whereby the external cables 60 can be disposed between the connector 50 and the PCU 70 so that it is possible to improve workability when the external cables 60 are to be connected between the connector 50 and the PCU 70.

In the connection structure 90 according to the present embodiment, the other end portion 24 of each of the three power line cables 20 (to which a corresponding one of the three first crimp terminals 26 is fixed) and the other end portions 44 of the respective two internal cables 40 (to which a corresponding one of the three second crimp terminals 46 is fixed) are located on respective opposite sides of the common plane S (on which the plate portion 26a of the corresponding one of the three first crimp terminals 26 and the plate portion 46a of the corresponding one of the three second crimp terminals 46 both lie). As compared with an arrangement in which the other end portion 24 of each of the three power line cables 20 and the other end portions 44 of the respective internal cables 40 are both located on the same side as one of the opposite sides of the common plane S, in this arrangement in which the other end portion 24 and the other end portions 44 are located on the respective opposite sides of the common plane S, when the first and second crimp terminals 26, 46 fixed to the other end portion 24 and the other end portions 44 are to be attached to the three attached portions 36 of the terminal block 30, they can be easily attached to the three attached portions 36 of the terminal block 30 even where only a small space is available for such an attaching operation, because the other end portion 24 and the other end portions 44 are located on the respective opposite sides of the common plane S and are not likely to interfere with each other.

In the connection structure 90 according to the present embodiment, the first crimp terminals 26 consist of three first terminals 26, the second crimp terminals 46 consist of three second crimp terminals 46, and the attached portions 36 of the terminal block 30 consists of three attached portions 36, and the other end portions 44 of the three pairs of the internal cables 40, to which the three second crimp terminals 46 are fixed, extend in the Z direction as the same direction, wherein at least one of the three attached portions 36 is offset from the other of the three attached portions 36 in at least one of the X direction and Y direction that are orthogonal to the Z direction. The feature that at least one of the three attached portions 36 is offset from the other of the three attached portions 36 in at least one of the X direction and Y direction, means that the three attached portions 36 do not lie on a single straight line that extends in the X direction and/or Y direction. As compared with an arrangement in which all of the three attached portions 36 lie on a single straight line, in this arrangement in which the three attached portions 36 do not lie on a single straight line, when the three second crimp terminals 46, which are fixed to the other end portions 44 of the three pairs of the internal cables 40, are to be attached to the three attached portions 36 of the terminal block 30, they can be easily attached to the respective three attached portions 36 even where only a small space is available for such an attaching operation in the terminal block 30, because the three second crimp terminals 46 are not likely to interfere with one another.

In the connection structure 90 according to the present embodiment, the three attached portions 36 are located in respective three positions that cooperate with one another to define the isosceles triangle as seen from the X direction (i.e., direction perpendicular to the common plane S), and two of the three sides of the isosceles triangle have the same length that is smaller than a length of another one of the three sides. The feature that the three positions of the respective three attached portions 36 cooperate with one another to define the isosceles triangle as seen from the X direction, means that the three attached portions 36 do not lie on a single straight line. Owing this feature, when the three second crimp terminals 46, which are fixed to the other end portions 44 of the three pairs of the internal cables 40, are to be attached to the three attached portions 36 of the terminal block 30, the three second crimp terminals 46 are not likely to interfere with one another. Further, since two of the three sides of the isosceles triangle have the same length that is smaller than a length of another one of the three sides, it is possible to reduce a size of the terminal block 30, without reducing distances among the three attached portions 36, as seen from the X direction, as compared with an arrangement in which the two of the three sides of the isosceles triangle, which have the same length, are longer than the other one of the three sides. Thus, it is possible to establish a structure, which enables the three second crimp terminals 46 to be unlikely to interfere with one another in the attaching operation for attaching the three second crimp terminals 46 to the respective three attached portions 36, and which reduce the size of the terminal block 30 as seen in the X direction.

While the preferred embodiment of this invention has been described in detail by reference to the drawings, it is to be understood that the invention may be otherwise embodied.

In the above-described embodiment, each of the three power line cables 20 connected to the three phases of the three-phase winding are branched into corresponding two of the six internal cables 40 in a corresponding one of the three attached portions 36 of the terminal block 30. However, this arrangement is not essential to the present invention. For example, each of the power line cables 20 may be branched into three or more internal cables 40 in a corresponding one of the attached portions 36 of the terminal block 30.

In the above-described embodiment, the other end portion 24 of each of the three power line cables 20, which is crimped by the crimp portion 26b of a corresponding one of the three first crimp terminals 26, and the other end portions 44 of corresponding two of the six internal cables 40, which are crimped by the crimp portion 46b of a corresponding one of the three second crimp terminals 46, are located on respective opposite sides of a corresponding one of the three common planes S. However, this arrangement is not essential to the present invention. Even where the crimped other end portion 24 of each power line cable 20 and the crimped other end portions 44 of the corresponding two internal cables 40 are not located on the respective opposite sides of the corresponding common plane S, it is possible to improve the flexibility of the external cables 60 and make the external cables 60 to be easily disposed between the connector 50 and the CPU 70, by reducing the cross-sectional area of each of the external cables 60 while suppressing increase of the power loss and increase of the heat generation in the external cables 60 as a whole.

In the present embodiment, the three attached portions 36, to which the respective three pairs of the first and second crimp terminals 26, 46 are attached, are disposed in respective positions that are offset from another, as viewed from the Z direction. However, this arrangement is not essential to the present invention. For example, the three attached portions 36 do not necessarily have to be offset from one another.

In the above-described embodiment, the three attached portions 36 are located in the respective three positions that cooperate with one another to define the isosceles triangle as seen from the X direction, such that two of the three sides of the isosceles triangle have the same length that is smaller than the length of another one of the three sides. However, this arrangement is not essential to the present invention. The triangle defined by the three attached portions 36 does not necessarily have to be an isosceles triangle. Further, where the defined triangle is an isosceles triangle, the two sides equal in length do not necessarily have to be shorter than the other side and may be longer than the other side.

In the above-described embodiment, the electric motor MG is a three-phase synchronous motor. However, the electric motor MG does not necessarily have to be a three-phase electric motor, and does not necessarily have to be a synchronous electric motor, either. Further, the electric motor MG does not necessarily have to be a motor generator and may be an electric motor having only one of the motor function and the generator function.

It is to be understood that the embodiment described above is given for illustrative purpose only, and that the present invention may be embodied with various modifications and improvements which may occur to those skilled in the art.

### NOMENCLATURE OF ELEMENTS

10: stator
14: coil
20: power line cable (first connection line)
24: other end portion (connector-side end portion)
26: first crimp terminal (first terminal)
26a: plate portion (contact portion)
26b: crimp portion (fixed portion)
30: terminal block
36: attached portion
40: internal cable (second connection line)
44: other end portion (coil-side end portion)
46: second crimp terminal (second terminal)
46a: plate portion (contact portion)
46b: crimp portion (fixed portion)
50: connector
52: inside terminal portion (terminal portion)
70: power control unit (power source)
MG: electric motor
S: common plane

What is claimed is:

1. A connection structure for connecting between a coil of a stator of an electric motor and a connector connected to a power source, the connection structure comprising:
at least one first connection line each of which connected to the coil and includes a connector-side end portion;
at least one first terminal each of which is fixed to the connector-side end portion of a corresponding of the at least one first connection line;
a plurality of second connection lines connected to respective terminal portions of the connector and including respective coil-side end portions that are jointed to each other;
at least one second terminal each of which is fixed to the coil-side end portions of the respective second connection lines; and
a terminal block including at least one attached portion,
wherein each of the at least one first terminal and a corresponding one of the at least one second terminal are attached to a corresponding one of the at least one attached portion of the terminal block, and are connected to each other.

2. The connection structure according to claim 1,
wherein each of the at least one first terminal includes a fixed portion at which the each of the at least one first terminal is fixed to the connector-side end portion of a corresponding one of the at least one first connection line,
wherein each of the at least one second terminal includes a fixed portion at which the each of the at least one second terminal is fixed to the coil-side end portions of the respective second connection lines,
wherein each of the at least one first terminal further includes a contact portion and each of the at least one second terminal further includes a contact portion, such that the contact portion of each of the at least one first terminal and the contact portion of a corresponding one of the at least one second terminal both lie on a common plane so as to be in contact with each other, and
wherein the connector-side end portion of each of the at least one first connection line and the coil-side end portions of the respective second connection lines are located on respective opposite sides of the common plane.

3. The connection structure according to claim 2,
wherein the at least one first terminal consists of three first terminals, the at least one second terminal consists of three second terminals, and the at least one attached portion of the terminal block consists of three attached portions, such that each of the three first terminals and a corresponding one of the three second terminals are attached to a corresponding one of the three attached portions, and such that the three second terminals are fixed to the coil-side end portions of three sets of the second connection lines,
wherein the coil-side end portions of the three sets of the second connection lines extend in a predetermined direction, and
wherein at least one of the three attached portions is offset from the other of the three attached portions in a direction orthogonal to the predetermined direction.

4. The connection structure according to claim 3,
wherein the three attached portions are located in respective three positions that cooperate with one another to define an isosceles triangle as seen from a direction perpendicular to the common plane, and
wherein two of three sides of the isosceles triangle have the same length that is smaller than a length of another one of the three sides.
